(19) United States
(12) Patent Application Publication
(10) Pub. No.: US 2019/0385396 A1
(43) Pub. Date: Dec. 19, 2019

(54) DUAL FUNCTION PAYMENT CARD FOR IMPLEMENTING A "GET OUT THE VOTE" CAMPAIGN

(71) Applicant: MASTERCARD INTERNATIONAL INCORPORATED, Purchase, NY (US)

(72) Inventors: Vignesh JOTHIPANDIAN, Pune (IN); Sandhya NAIR, Pune (IN)

(21) Appl. No.: 16/434,921

(22) Filed: Jun. 7, 2019

(30) Foreign Application Priority Data
Jun. 15, 2018 (IN) 201811022548

(51) Int. Cl. G07C 13/00; G06Q 20/34; G06Q 20/36

(52) U.S. Cl. CPC G07C 13/00; G06Q 2230/00; G06Q 20/363; G06Q 20/3574

(57) ABSTRACT

The invention relates to a dual function payment card, and a digital wallet platform that implements campaigns and schemes for improving voter participation in elections. The invention seeks to increase voter participation in an election event, by (i) receiving confirmation of a cardholder's participation in an election event, wherein said cardholder is associated with a dual function payment card, (ii) determining an election event participation state change associated with the dual function payment card, (iii) updating a recorded election event participation state of the dual function payment card based on the determined election event participation state change, and (iv) receiving the updated election event participation state at a processor wallet application server configured to implement functionality associated with a wallet account corresponding to the cardholder, wherein said dual function payment card has been enrolled with said wallet account.

### TECHNICAL FIELD

The invention relates to “Get Out The Vote” technologies for motivating participation in elections and improving voter turnout. In particular, the invention relates to a dual function payment card, and a digital wallet platform that implements campaigns and schemes for improving voter participation in elections.

### BACKGROUND

Motivating citizens to participate in elections is a critical part of the democratic process. “Get Out The Vote” (GOTV) techniques and technologies are increasingly used to improve the participation of citizens in elections, and to ensure that citizens exercise their democratic and constitutional mandate by voting.

Existing “Get Out The Vote” efforts are directed either towards (i) field operations—consisting of campaigns run by political parties, labor unions and grassroots organizations with the purpose of targeting voters and communicating with them through phone calls, visits, and emails to encourage them to vote, or (ii) “Get Out The Vote” drives—consisting of campaigns run by non-partisan, non-profit organizations and including television, radio and print ads, public service announcements etc., with the aim of educating and motivating citizens to vote.

Both types of efforts have limited success since they do not really provide participating voters with any form of social or financial reward.

There is accordingly a need for technology driven “Get Out The Vote” solutions that provide rewards for individuals who participate in elections—while simultaneously avoiding influencing a voter's decision on whom to vote for—thereby preserving the independence and sanctity of the electoral process.

### BRIEF SUMMARY

In particular, the invention relates to a dual function payment card, and a digital wallet platform that implements campaigns and schemes for improving voter participation in elections.

An embodiment of the invention provides a method for increasing voter participation in an election event, the method comprising (i) receiving confirmation of a cardholder's participation in an election event, wherein said cardholder is associated with a dual function payment card, (ii) determining an election event participation state change associated with the dual function payment card, wherein said election event participation state change is determined based on (a) a prior election event participation state of the dual function payment card, (b) the received confirmation that the cardholder has participated in the election event, and (c) one or more predefined participation state change rules, (iii) updating a recorded election event participation state of the dual function payment card based on the determined election event participation state change, and (iv) receiving the updated election event participation state at a processor wallet application server configured to implement functionality associated with a wallet account corresponding to the cardholder, wherein said dual function payment card has been enrolled with said wallet account.

The step of receiving the updated election event participation state may be performed at a processor implemented within a client terminal that enables access to the wallet account. Alternatively, at least the step of receiving the updated election event participation state may be performed at a wallet application server configured to implement functionality associated with a wallet account corresponding to the cardholder, wherein said dual function payment card has been enrolled with said wallet account.

In an embodiment of the invention, the wallet application server identifies a visual representation template corresponding to the dual function payment card, and wherein identification of the visual representation template comprises selection of said visual representation template from a plurality of available visual representation templates, and said selection is based on (i) the received updated election event participation state of the dual function payment card and (ii) a predefined set of display state rules.

A further embodiment comprises rendering a visual representation of the dual function payment card on a display interface, wherein visual characteristics of the rendered visual representation of the dual function payment card are determined by the identified visual representation template.

In a particular embodiment, visual characteristics of the rendered visual representation of the dual function payment card that are determined by the identified visual representation template may include a specific color configuration used to display the dual function payment card on the display interface. In a further embodiment, a first color configuration determined by a first visual representation template within the plurality of visual representation templates is different from a second color configuration determined by a second visual representation template within the plurality of visual representation templates.

One or more embodiments of the method may additionally comprise the steps of (i) receiving a payment instruction for payment (for a payment transaction) based on the dual function payment card, (ii) identifying a transaction offer applicable to the payment transaction of the payment, wherein identification of the transaction offer is based on an identified election event participation state associated with the dual function payment card, and (iii) implementing the payment transaction and the identified transaction offer.

The invention also provides a method for increasing voter participation in an election event, comprising (i) receiving at a wallet application server an election event participation state corresponding to a dual function payment card, wherein said wallet application server is configured to maintain a wallet account corresponding to a cardholder of said dual function payment card, and wherein said dual function payment card has been enrolled with said wallet account, (ii) identifying a visual representation template corresponding to the dual function payment card, wherein identification of the visual representation template comprises selection of said visual representation template from a plurality of available visual representation templates, and said selection is based on (a) the received election event participation state of the dual function payment card and (b) a predefined set of display state rules, and (iii) rendering a visual representation of the dual function payment card on a display interface, wherein visual characteristics of the rendered visual representation of the dual function payment card are determined by the identified visual representation template.

In an embodiment, the election event participation state corresponding to the dual function payment card may be determined based on a received confirmation of the cardholder's participation in an election event. and on determination of an election event participation state change associated with the dual function payment card—wherein said election event participation state change is determined based on (i) a prior election event participation state of the dual function payment card, (ii) the received confirmation that the cardholder has participated in the election event, and (iii) one or more predefined participation state change rules.

The invention additionally presents a method for increasing voter participation in an election event, comprising (i) receiving a payment instruction for payment based on a dual function payment card, (ii) identifying a transaction offer applicable to the payment transaction of the payment, wherein identification of the transaction offer is based on an identified election event participation state associated with the dual function payment card, and (iii) implementing the payment transaction and the identified transaction offer—wherein identification of the election event participation state corresponding to the dual function payment card is based on (iv) a received confirmation of the cardholder's participation in an election event, and (v) determination of an election event participation state change associated with the dual function payment card, wherein said election event participation state change is determined based on (a) a prior election event participation state of the dual function payment card, (b) the received confirmation that the cardholder has participated in the election event, and (c) one or more predefined participation state change rules.

In another embodiment, the invention provides a system for increasing voter participation in an election event. The system comprises an issuer network server configured for (i) receiving confirmation of a cardholder's participation in an election event, wherein said cardholder is associated with a dual function payment card issued by an issuer institution corresponding to said issuer network server, (ii) determining an election event participation state change associated with the dual function payment card, wherein said election event participation state change is determined based on (a) a prior election event participation state of the dual function payment card, (b) the received confirmation that the cardholder has participated in the election event, and (c) one or more predefined participation state change rules, (iii) updating a recorded election event participation state of the dual function payment card based on the determined election event participation state change.

The system may additionally include either of a wallet application server or a processor implemented within a client terminal that enables access to a wallet account, configured to (i) maintain a wallet account corresponding to the cardholder, wherein said dual function payment card has been enrolled with said wallet account, and (ii) receive the updated election event participation state from the issuer network server.

In a system embodiment, the wallet application server may be configured to identify a visual representation template corresponding to the dual function payment card, wherein said identification of the visual representation template comprises selection of said visual representation template from a plurality of available visual representation templates, and wherein said selection is based on (i) the received updated election event participation state of the dual function payment card and (ii) a predefined set of display state rules.

The wallet application server or wallet application software in communication with said wallet application server may be configured to render a visual representation of the dual function payment card on a display interface, wherein visual characteristics of the rendered visual representation of the dual function payment card are determined by the identified visual representation template.

In a system embodiment, visual characteristics of the rendered visual representation of the dual function payment card that are determined by the identified visual representation template include a specific color configuration used to display the dual function payment card on the display interface. In a particular embodiment, a first color configuration determined by a first visual representation template within the plurality of visual representation templates is different from a second color configuration determined by a second visual representation template within the plurality of visual representation templates.

The system may additionally be configured to (i) receive a payment instruction for payment based on the dual function payment card, (ii) identify a transaction offer applicable to the payment transaction of the payment, wherein identification of the transaction offer is based on an identified election event participation state associated with the dual function payment card, and (iii) implement the payment transaction and the identified transaction offer.

The invention additionally provides a wallet application platform configured for increasing voter participation in an election event. Said wallet application platform comprises a server configured to (i) maintain a wallet account corresponding to a cardholder of a dual function payment card, wherein said dual function payment card has been enrolled with said wallet account, (ii) receive an election event participation state corresponding to the dual function payment card, (iii) identify a visual representation template corresponding to the dual function payment card, wherein identification of the visual representation template comprises selection of said visual representation template from a plurality of available visual representation templates, and said selection is based on (a) the received election event participation state of the dual function payment card and (b) a predefined set of display state rules, and (iv) implement rendering of a visual representation of the dual function payment card on a display interface, wherein visual characteristics of the rendered visual representation of the dual function payment card are determined by the identified visual representation template.

In said system embodiment, the election event participation state corresponding to the dual function payment card may be determined based on (i) a received confirmation of the cardholder's participation in an election event, and (ii) determination of an election event participation state change associated with the dual function payment card, wherein said election event participation state change is determined based on (a) a prior election event participation state of the dual function payment card, (b) the received confirmation that the cardholder has participated in the election event, and (c) one or more predefined participation state change rules.

The invention additionally provides a system configured for increasing voter participation in an election event, comprising a server configured to (i) receive a payment instruction for payment based on a dual function payment card, (ii) identify a transaction offer applicable to the payment transaction of the payment, wherein identification of the transaction offer is based on an identified election event participation state associated with the dual function payment card, and (iii) implement the payment transaction and the identified transaction offer. Identification of the election event participation state corresponding to the dual function payment card may be based on (i) a received confirmation of the cardholder's participation in an election event, and (ii) determination of an election event participation state change associated with the dual function payment card, wherein said election event participation state change is determined based on (a) a prior election event participation state of the dual function payment card, (b) the received confirmation that the cardholder has participated in the election event, and (c) one or more predefined participation state change rules.

### BRIEF DESCRIPTION OF THE DRAWINGS

FIG. 1 illustrates an exemplary dual function payment card of a type that may be used for implementing the present invention.

FIGS. 2A and 5 illustrate system environments for implementing “Get Out The Vote” solutions in accordance with the present invention.

FIGS. 2B and 2D illustrate exemplary embodiments of a wallet application server for implementing the teachings of the present invention.

FIG. 2C illustrates an exemplary embodiment of an electoral authority server for implementing the teachings of the present invention.

FIGS. 3A to 3D, 6A, 7 and 8 illustrate methods for implementing a “Get Out The Vote” solution in accordance with the present invention.

FIGS. 3E to 311 and 6B are simplified sequence flow diagrams illustrating the communication flows between system entities in accordance with embodiments of the present invention.

FIG. 4 illustrates an exemplary template of data records or data record templates that may be used to implement embodiments of the present invention.

FIG. 9 illustrates an exemplary computer system according to which various embodiments of the present invention may be implemented.

### DETAILED DESCRIPTION

The invention provides “Get Out The Vote” technologies for motivating participation in elections and improving voter turnout.

For implementing “Get Out The Vote” technologies, the invention relies on a dual function payment card that may be issued under authorization of a government body, and provides the functionality of (i) a payment card for electronic payment transactions and (ii) a government issued identification.

It would be understood that the term “payment card” whenever used in this specification may refer to any physical or electronic card that provides the functionality of credit cards, debit cards, charge cards, stored-value cards, prepaid cards, fleet cards, virtual payment numbers, virtual card numbers, controlled payment numbers, etc. The term “government issued identification” refers to any form of valid government issued identification.

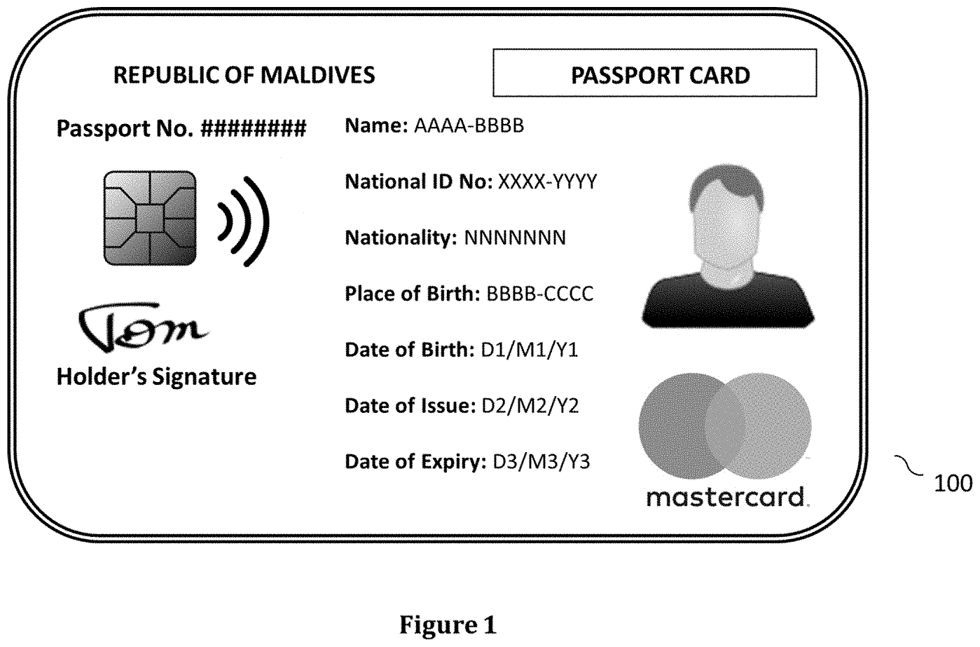

An example of a dual functionality payment card of the type described above is illustrated in FIG. 1—which illustrates a dual function payment card 100 of a type that is issued by the Government of Maldives in partnership with Mastercard® (the Maldives Passport Card).

In brief, the Maldives Passport card is a Mastercard Biometric Debit Card issued by the Bank of Maldives. It comprises a dual interface chip card with additional features and applications—and consolidates the cardholder's passport, national ID and driving license into a single instrument. The Maldives Passport Card serves as an identity travel document complying with International Civil Aviation Organization (ICAO) standards—allowing it to be used at e-gates at the Maldives International Airport, while simultaneously serving as identity verification for law enforcement agencies, and for benefiting from government services such as medical services and other e-services. The card additionally includes biometric data of the cardholder.

While the illustration in FIG. 1 is of a Maldives Passport Card, it would be understood that the solutions of the present invention may be equally implemented through any other dual function payment card that provides the functionality of (i) a payment card for electronic payment transactions and (ii) a government issued identification document.

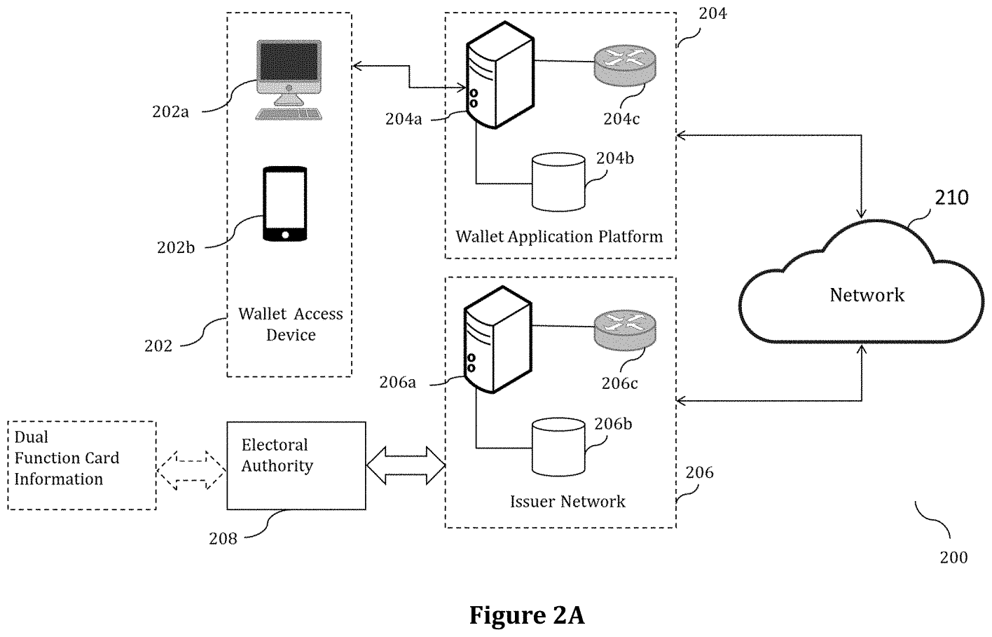

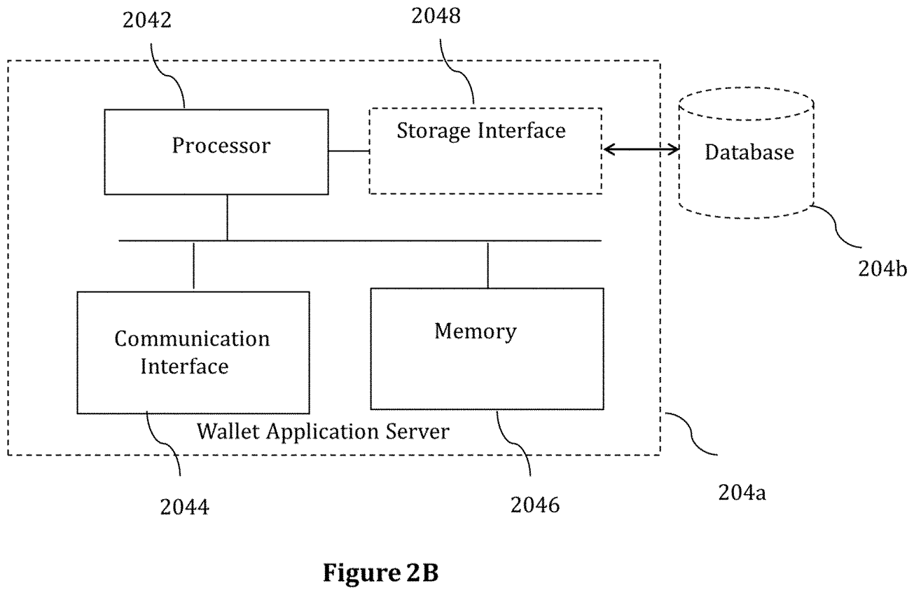

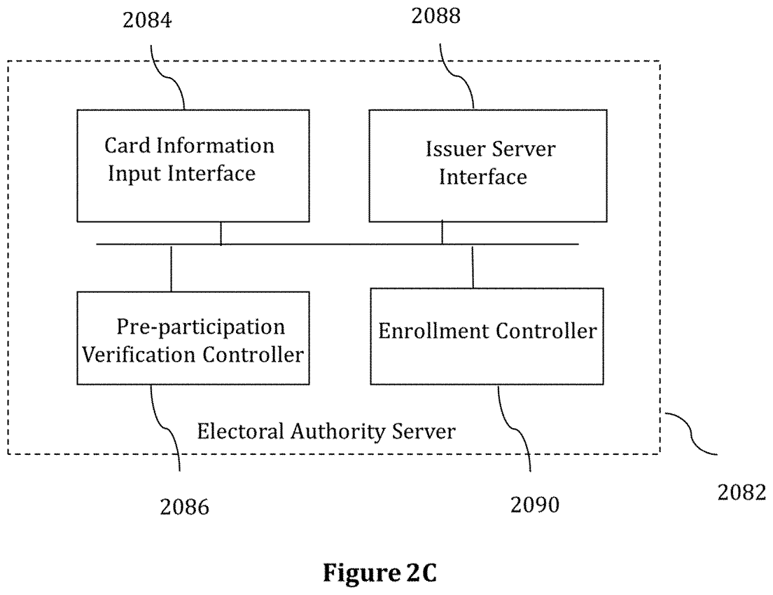

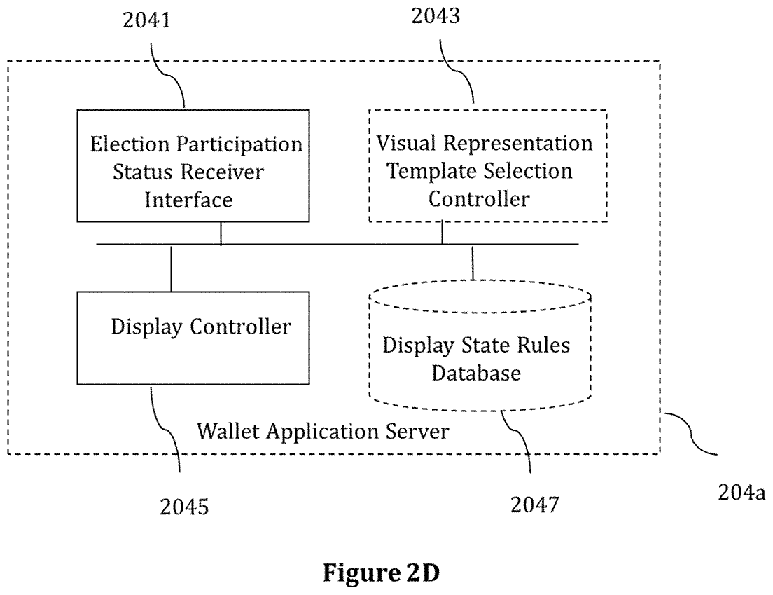

Implementing the solutions of the present invention requires the dual function payment card to be enrolled with a digital wallet platform. FIG. 2A illustrates a system environment 200 that may be used to implement the solutions of the present invention.

FIG. 2A illustrates a system environment 200 that can be used for implementing the “Get Out The Vote” solutions of the present invention.

System environment 200 includes wallet access device 202, wallet application platform 204, issuer network 206, electoral authority 208 and communication network 210.

Wallet access device 202 may comprise any electronic data processing device having network communication capabilities that can be used to access and operate digital wallet application software, and may include without limitation a computer/client terminal 202a or smartphone 202b. Wallet access device 202 may be configured for network communication with wallet application platform 204.

Wallet application platform 204 comprises wallet application platform server 204a, wallet application platform database 204b and wallet application platform interface gateway 204c. Wallet application platform server 204a is configured to provide and enable access to network based digital wallet services through wallet application software implemented on wallet access device 202 or through browser based access from said wallet access device 202. Wallet application platform database 204b is configured to store data corresponding to wallet accounts created at said wallet application platform 204. Wallet application platform interface gateway 204c may include a hardware or software network gateway configured to enable wallet application platform 204 for network based data communication.

For the purposes of this written description, the term “issuer” refers to a financial institution that issues the dual function payment cards and maintains a contract with a customer or card holder for repayment or settlement of purchases made on said payment card. Issuer network 206 is a communication network corresponding to an issuer institution that has issued one or more payment cards, and includes hardware, software and other equipment used by an issuer to transmit and process payment card transactions and information related to customers, payment cards and transactions. Issuer network 206 comprises issuer network server 206a, issuer network database 206b and issuer network interface gateway 206c. Issuer network server 206a may be configured to receive and process information relating to payment card transactions. Issuer network database 206b stores data corresponding to payment cards issued by the issuer, and transactions related thereto. Issuer network interface gateway 206c may include a hardware or software network gateway configured to enable issuer network 206 for network communications.

System environment 200 additionally includes network 210 for facilitating communication between wallet application platform 204 and issuer network 206. In an embodiment network 210 may comprise a card network i.e. an intermediary network between an acquirer bank and an issuer bank (for example, Mastercard® or Visa®). The card network primarily coordinates payment card transactions between acquirers and issuers, and additionally coordinates clearing and settlement services to transfer payments from issuers to merchants. In another embodiment, network 210 may comprise any communication network that enables data communication between two entities—for example, the internet.

System environment 200 additionally includes electoral authority 208—which electoral authority is an authorized government institution with a statutory or constitutional mandate to organize or conduct an election event (for example, an election commission authorized to organize and conduct presidential, ministerial, legislative or municipal elections within a specific jurisdiction). It will be noted that electoral authority 208 may communicate with or submit information to issuer network 206 (according to embodiments discussed in more detail below), which communications or submissions may be either electronic/network based or alternatively may be through physical submission.

FIG. 2B is a simplified block diagram of an embodiment of a wallet application server 204a of the type illustrated in FIG. 2A. Wallet application server 204a comprises at least one processor 2042 for executing instructions. Said instructions may be stored in memory 2046. Processor 2042 may include one or more processing units. The processor 2042 may be communicably coupled with communication interface 2044 such that wallet application server 204a is enabled for communication with any electronic device having network communication capabilities (e.g. with any one or more of wallet access device 202 and issuer network 206), or with any entity connected to network 210.

Processor 2042 may additionally be communicably coupled to database 204b—which database 204b includes one or more non-transient memory devices configured for storing and retrieving data, which data includes data of the type stored in wallet application server data records—for example data records concerning individuals having digital wallet accounts with said wallet application server 204a. Database 204b may include multiple storage units such as hard disks or solid state disks in a redundant array of inexpensive disks (RAID) configuration. Database 204b may also include a storage area network and/or a network attached storage (NAS) system.

In some embodiments database 204b may be integrated within wallet application server 204a and in other embodiments may be external to said wallet application server 204a and may be accessed by the wallet application server 204a through storage interface 2048. Storage interface 2048 may include for example, any of an Advanced Technology Attachment (ATA) adapter, a Serial ATA (SATA) adapter, a network adapter, or any other component providing processor 2042 with access to database 204b.

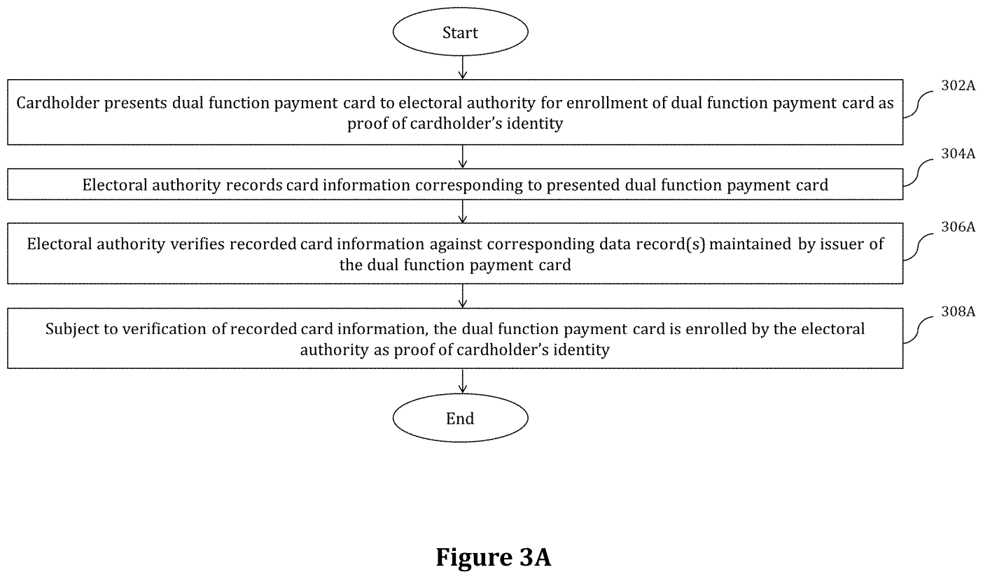

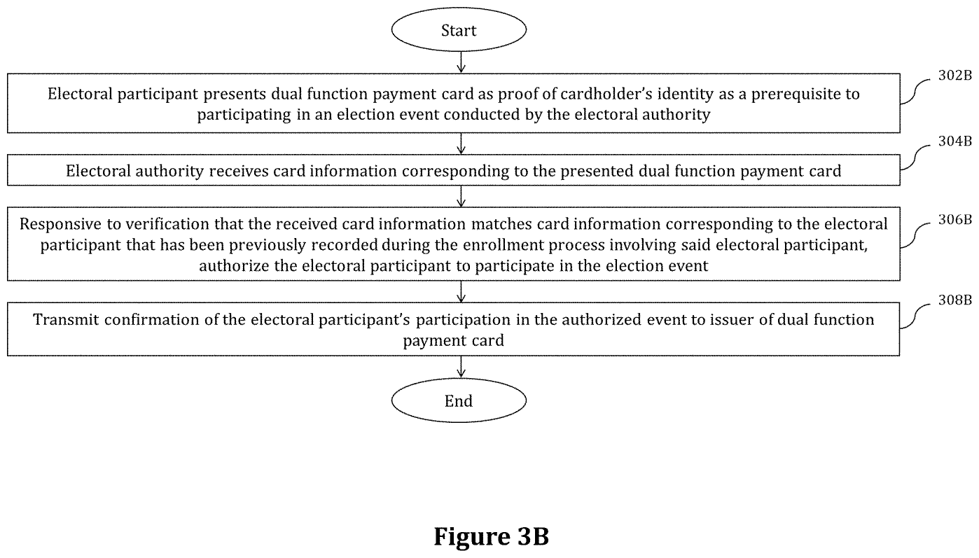

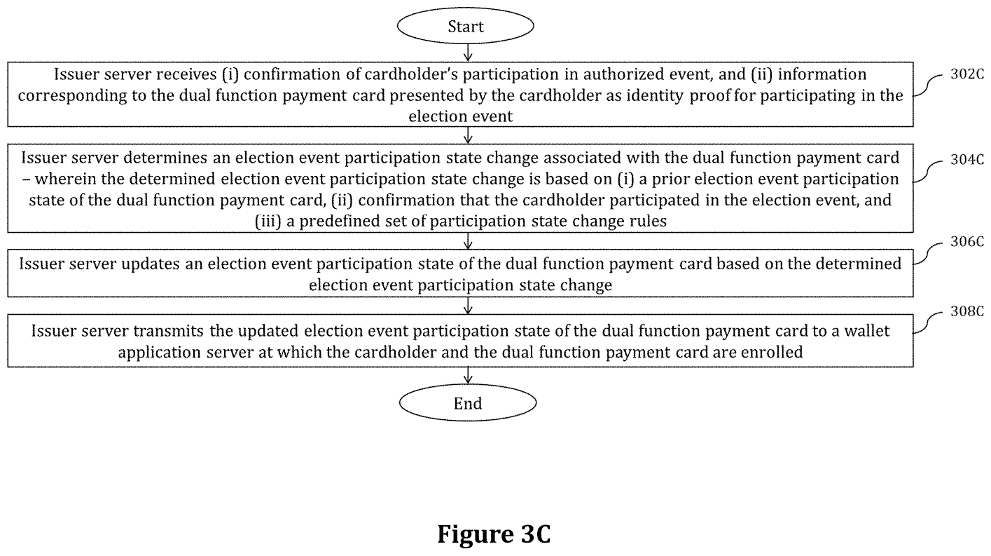

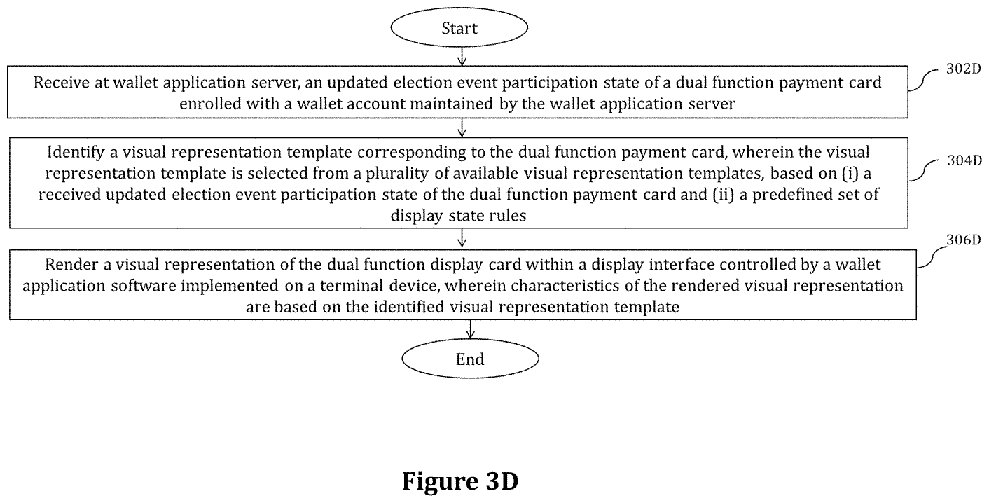

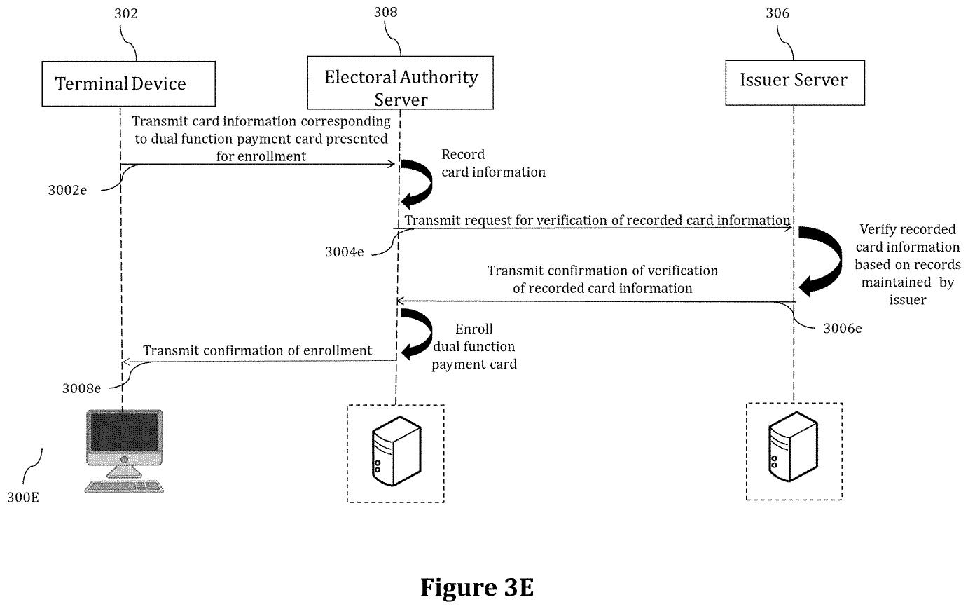

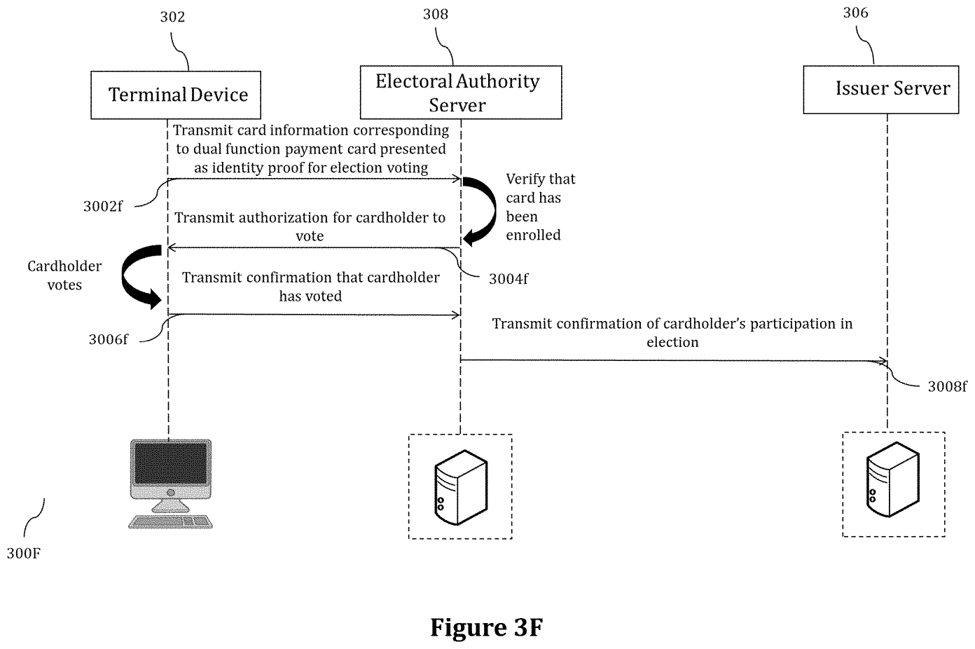

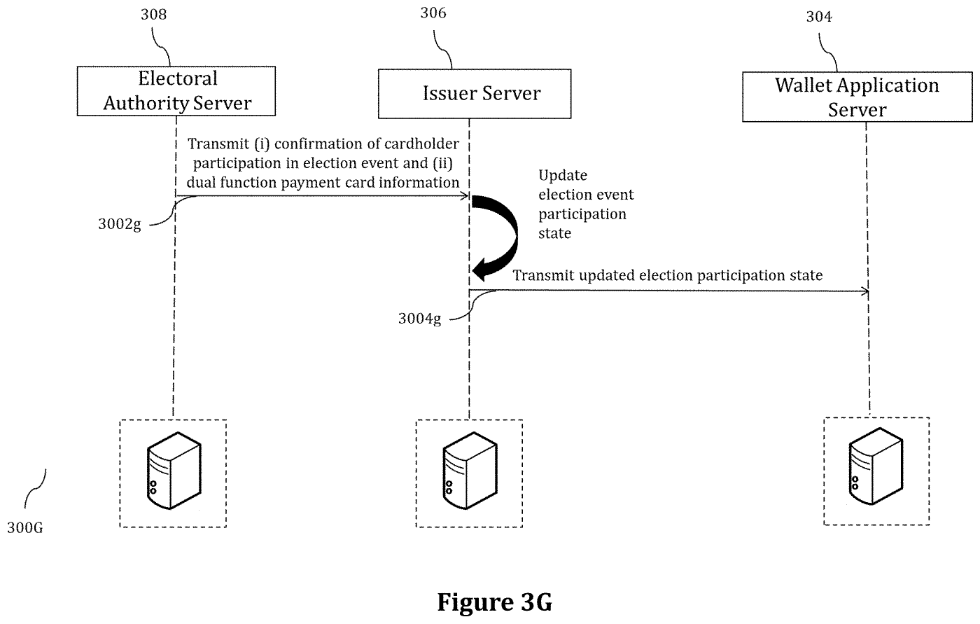

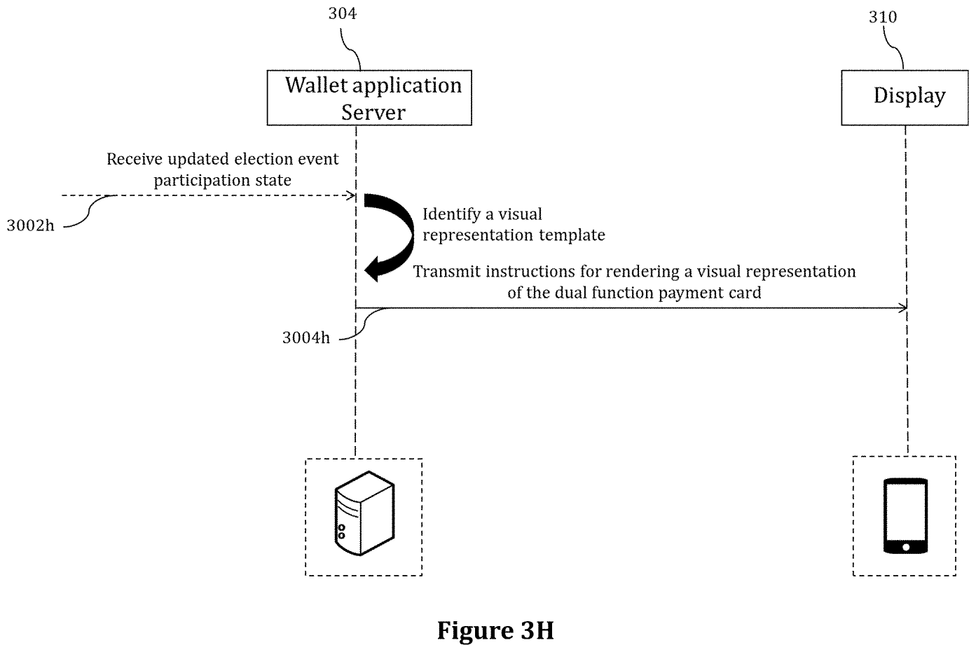

FIG. 2C is a simplified block diagram of an embodiment of an electoral authority server 2082 of a type that may be implemented by electoral authority 208 illustrated in FIG. 2A. Electoral authority server 2082 may be configured to implement method steps of the present invention, and in certain particular embodiments, may be configured to implement the methods described in connection with FIG. 3A and/or FIG. 3B in more detail hereinbelow. Electoral authority server 2028 comprises a card information input interface 2084, a pre-participation verification controller 2086, an issuer server interface 2088 and an enrolment controller 2090.

Card information input interface 2084 comprises a processor implemented interface that may be used for receiving at electoral authority server 2082 information identifying a dual function payment card that has been presented by a cardholder to electoral authority 208. Said card information input interface 2084 may enable a cardholder or an operator of a client terminal to input dual function payment card information for transmission to or receipt at electoral authority server 2082. In various embodiments, said card information input interface 2084 may enable electoral authority server to receive card information that is input through a client terminal that is in network communication with electoral authority server 2082 or through one or more peripheral devices connected to such client terminal or connected directly to electoral authority server 2082. In an embodiment of the invention, the card information input interface 2084 may be configured to enable implementation of step 302A of FIG. 3A or steps 302B and/or 304B of FIG. 3B that are discussed in more detail below.

Pre-participation verification controller 2086 comprises a processor implemented controller configured to verify a dual function payment card presented by a cardholder seeking enrollment of said dual function payment card as proof of said cardholder's identity—by comparing information corresponding to the presented dual function payment card against data records maintained by the issuer of said dual function payment card. In an embodiment of the invention, the pre-participation verification controller 2086 may be configured to enable implementation of step 306A of FIG. 3A that is discussed in more detail below.

Issuer server interface 2088 comprises a network communication interface configured to enable network communication between electoral authority server 2082 and issuer server 206a.

Enrolment controller 2090 comprises a processor implemented controller configured to enroll a dual function payment card presented by a cardholder for enrolment purposes, at the electoral authority server 2082—in response to prior verification of said dual function payment card based on records maintained by the issuer of said dual function payment card. In an embodiment of the invention, the enrolment controller 2090 may be configured to enable implementation of step 308A of FIG. 3A that is discussed in more detail below.

FIG. 2D is a simplified block diagram of another embodiment of wallet application server 204a. The illustrated embodiment of wallet application server 204a may be configured to implement method steps of the present invention, and in certain particular embodiments, may be configured to implement the methods described in connection with FIG. 3D hereinbelow. In the illustrated embodiment, wallet application server 204a election participation status receiver interface 2041, visual representation template selection controller 2043, display controller 2045 and display state rules database 2047.

Election participation status receiver interface 2041 comprises a processor implemented interface that may be used for receiving at wallet application server 204a, an updated election event participation state of a dual function payment card enrolled with a wallet account maintained by the wallet application server 204a. In various embodiments, said interface 2041 may enable wallet application server 204a to receive updated election event participation states associated with a dual function payment card that is transmitted from an issuer server (for example issuer server 206a) to wallet application server 204a. In an embodiment of the invention, the election participation status receiver interface 2041 may be configured to enable implementation of step 302D of FIG. 3D that is discussed in more detail below.

Visual representation template selection controller 2043 comprises a processor implemented controller configured for identifying a visual representation template corresponding to a dual function payment card that is enrolled with the wallet application server 204a. As discussed in more detail in connection with FIG. 3D (for example, at step 304D), the visual representation template may be selected from a plurality of available visual representation templates, based on (i) a received updated election event participation state of the dual function payment card and (ii) a predefined set of display state rules.

Display state rules database 2047 comprises one or more non-transitory memory based databases that is used to retrievably store one or more display state rules that define how a display state change is to be determined based on an election event participation state of the dual function payment card.

Display controller 2045 comprises a processor implemented controller configured for rendering a visual representation of a dual function display card within a display interface controlled by a wallet application software implemented on a terminal device, wherein characteristics of the rendered visual representation are based on a visual representation template selected by visual representation template selection controller 2043. In an embodiment of the invention, display controller 2045 may be configured to enable implementation of step 306D of FIG. 3D that is discussed in more detail below.

FIGS. 3A to 3D illustrate methods for implementing a “Get Out The Vote” solution through the system environment 200 illustrated in FIG. 2A.

FIG. 3A illustrates a method of registering a cardholder of a dual function payment card with the electoral authority 208 for participation in an election event. At step 302A, the cardholder presents a dual function payment card (that has been issued to said cardholder) to the electoral authority for enrolment of the dual function payment card with the electoral authority so that said card may be used as proof of the cardholder's identity during an election event.

At step 304A, the electoral authority 208 records the card information corresponding to the presented dual function payment card. Recorded card information may include one or more of the cardholder name, date of birth, card number, unique government issued identification number, date of issue and/or date of expiry, or any other data/metadata associated with the presented dual function payment card.

Step 306A comprises verification of the recorded card information by the electoral authority 208 against corresponding data record(s) maintained by the issuer of the dual function payment card. In an embodiment, verification of the recorded card information may comprise retrieving from the issuer, data record(s) corresponding to the card number or the unique government issued identification number that has been recorded at step 304A. If the data items corresponding to the data record(s) retrieved from the issuer match the card information recorded by the electoral authority at step 304A, electoral authority 208 treats the recorded card information as verified. It would be understood that in various embodiments, the retrieval of data from the issuer and comparison of data may be implemented by means of network based communication between electoral authority 208 and issuer network 206. It would be understood that in alternate embodiments of the invention verification of the recorded card information by electoral authority 208 may be based on corresponding data record(s) maintained by any trusted third party, including without limitation the payment network, or a trusted third party intermediary company other than the payment network and the issuer.

Subject to verification of the recorded card information, step 308A comprises enrolling the dual function payment card (presented by the cardholder at step 302A) with the electoral authority 208 as acceptable proof of the cardholder's identity for the purposes of participation of said cardholder in the election event. In an embodiment, enrolment of the dual function payment card includes recording details of the dual function payment card in a database of enrolled dual function payment cards that is accessible by electoral authority 208.

FIG. 3E is a simplified sequence flow diagram 300E representing an exemplary embodiment of the method of registering a cardholder of a dual function payment card with the electoral authority 208 for participation in an election event, that has been discussed in connection with FIG. 3A. The sequence flow diagram 300E includes the method steps 302A to 308A of FIG. 3A—but which steps have not been described again for the sake of brevity. The steps illustrated in FIG. 3E comprise steps 3002e to 3008e implemented between client terminal device 302, electoral authority server 308 and issuer server 306.

At step 3002e card information corresponding to a dual function payment card presented by a cardholder for the purpose of enrolment for an upcoming election event is input at terminal device 302 and transmitted from said terminal device 302 to electoral authority server 308. It would be understood that terminal device 302 may comprise any network communication enabled terminal device that is in network communication with electoral authority server 308 for the purposes of providing information for enrolling individuals for an election event.

At step 3004e, subsequent to electoral authority server 308 recording the card information received at step 3002e, said electoral authority server 308 transmits a request for verification of the recorded card information to an issuer server 306. The recorded card information may include one or more of the cardholder name, date of birth, card number, unique government issued identification number, date of issue and/or date of expiry, or any other data/metadata associated with the presented dual function payment card. The issuer server 306 may comprise any server made available (for the purpose of verifying received dual function payment card information) by the issuer bank responsible for issuing the dual function payment card whose information is presently under verification.

Issuer server 306 thereafter verifies the received card information against corresponding data record(s) maintained by the issuer of the dual function payment card. In an embodiment, verification of the recorded card information may comprise retrieving from the issuer server, data record(s) corresponding to the card number or the unique government issued identification number that has been recorded by electoral authority server 308. If the data items corresponding to the data record(s) retrieved from the issuer match the card information recorded by the electoral authority server 308, the recorded card information may be treated as verified. It would be understood that in alternate embodiments of the invention verification of the recorded card information may be based on corresponding data record(s) maintained by any trusted third party, including without limitation the payment network, or a trusted third party intermediary company other than the payment network and the issuer.

Subject to positive verification of the recorded card information, step 3006e comprises transmitting from issuer server 306 (or from any other server that has been used for the purposes of verification of the recorded card information) to electoral authority server 308, a confirmation of verification of the recorded card information. Thereafter, responsive to electoral authority server 308 receiving a confirmation that the recorded card information has been successfully verified, said electoral authority server 308 may at step 3008e transmit confirmation of enrolment of the cardholder for the upcoming election event, to terminal device 302. It would be understood that in an embodiment, the card information received by the electoral authority server 308 at step 3002e may be recorded at said electoral authority server subsequent to receiving a confirmation of verification of the recorded card information.

FIG. 3B illustrates a method wherein a cardholder who has previously enrolled a dual function payment card as proof of identity for participation in an election event, uses the enrolled dual function payment card for participating in the election event.

At step 302B, an electoral participant presents the dual function payment card as proof of identity, as a prerequisite to being allowed to participate in an election event being conducted by electoral authority 208.

At step 304B, electoral authority 208 receives/obtains card information corresponding to the dual function payment card from the electoral participant. In an embodiment, receiving the card information may comprise receiving such information by way of manual input or by way of information extracted from a scanned image of the dual function payment card, or by any other form of information retrieval—for example by swiping the dual payment card through a device having a magnetic stripe reader, or through near-field-communication (NFC) based communications between an NFC enabled terminal and an NFC enabled dual function payment card.

At step 306B, responsive to verifying that the received card information matches card information corresponding to the electoral participant, and that has been previously recorded during the process of enrolling said electoral participant with the electoral authority 208 (as described in connection with FIG. 3A), the electoral participant is authorized to participate in the election event.

At step 308B, confirmation of the electoral participant's participation in the election event is transmitted to the issuer of the dual function payment card. It would be understood that confirmation of the electoral participant's participation in the election event may be forwarded to the issuer 206 by way of a periodic paper based update or through a data file based update that is physically forwarded to the issuer 206—whereafter, the forwarded information may be recorded by the issuer 206 in its own databases. Alternatively, confirmation of the cardholder's participation in the election event may be electronically forwarded to the issuer 206 by way of electronic network based communication from electoral authority 208.

FIG. 3F is a simplified sequence flow diagram 300F representing an exemplary embodiment of the method wherein a cardholder who has previously enrolled a dual function payment card as proof of identity for participation in an election event, uses the enrolled dual function payment card for participating in the election event. The sequence flow diagram 300F includes the method steps 302B to 308B of FIG. 3B—but which steps have not been described again for the sake of brevity. The steps illustrated in FIG. 3F comprise steps 3002f to 3008f implemented between client terminal device 302, electoral authority server 308 and issuer server 306.

At step 3002f, card information corresponding to a dual function payment card presented by a cardholder (as proof of said cardholder's identity for the purpose of identity authentication at an election event) is received at terminal device 302 and is transmitted from said terminal device 302 to electoral authority server 308. Terminal device 302 is a terminal device being used for the purposes of inputting identity information for identity verification purposes (as a prerequisite for permitting individuals to vote in an election event). Said terminal device may comprise any network communication enabled terminal device that is in network communication with electoral authority server 308.

At step 3004f (and subsequent to electoral authority server 308 ascertaining that said dual function payment card has been previously enrolled with the electoral authority server for use as identity proof in said election event), said electoral authority server 308 transmits an authorization message to terminal device 302—confirming that the cardholder corresponding to said dual function payment card is authorized to vote in the election event.

The cardholder thereafter votes, and step 3006f comprises transmission of confirmation that said cardholder has voted, from terminal device 302 to electoral authority server 308.

At step 3008f, electoral authority server thereafter transmits a communication to issuer server 306—confirming that the cardholder associated with said dual function payment card has voted in the election event. In an embodiment, said communication may additionally specify that a specific dual function payment card associated with said cardholder was used as identity proof to participate in said election event.

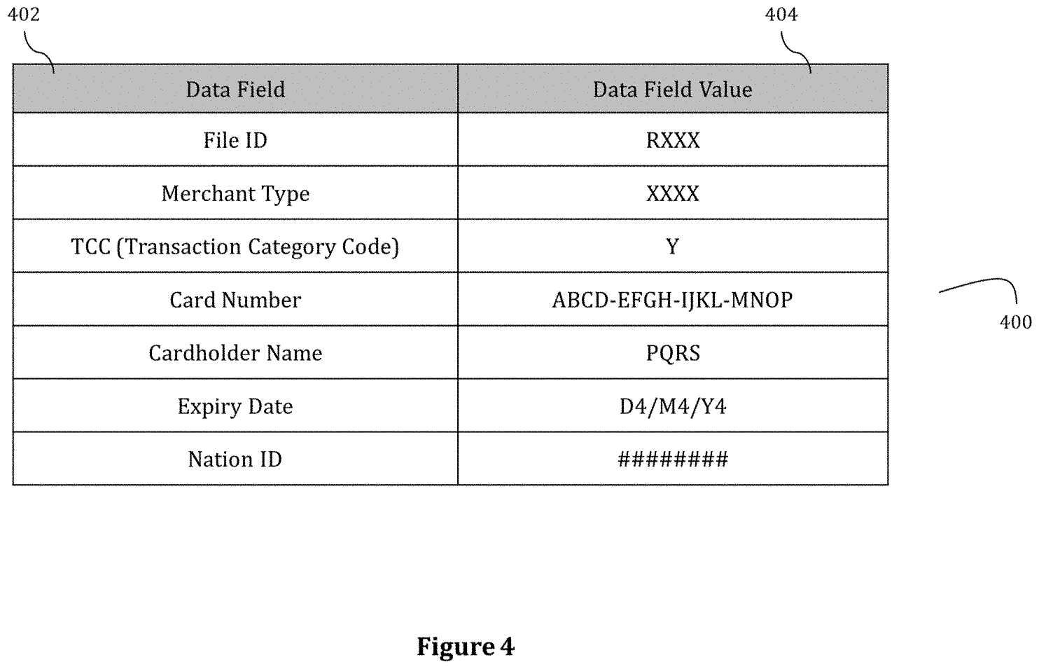

FIG. 4 illustrates an exemplary template 400 of data records or data record templates that may be used for transmitting election participation data to an issuer/issuer server (for example, issuer network 206 in FIG. 2 or issuer server 306 in FIG. 3E). Said exemplary template includes a plurality of data fields 402—each having a recorded corresponding data value 404. In the illustrated template 400, the data fields 402 include a File ID (i.e. a bulk or batch file ID under which multiple participation records are transmitted from electoral authority 208/electoral authority server 308 to issuer network 206/issuer server 306), a merchant type (comprising a standard merchant type identifier that has been allocated to the electoral authority, which can be used by the issuer to categorize the received records according to their origin), a transaction category code that has been allocated to a specific election event (and which can be used to correlate the received data record to a specific election event in which an electoral participant has participated), the unique payment card number, the cardholder name, card expiry date, and nation ID/unique government ID that has been assigned to the cardholder by the concerned government authority that has issued the dual function payment card.

The issuer network 206/issuer server 306 may extract the information that has been received from electoral authority 208/electoral authority server 308 in the above format (or any other format) and may use it to update issuer records stored by issuer server 206a/issuer server 306 (for example at issuer database 206b), regarding participation of a cardholder in one or more specific election events conducted by electoral authority 208.

FIG. 3C illustrates a method for updating information regarding participation of a cardholder in an election event at a wallet application platform 204—at which platform 204 the cardholder has enrolled the dual function payment card for digital wallet services using said dual function payment card.

At step 302C, issuer server 206a receives (i) confirmation of the cardholder's participation in an election event, and (ii) information corresponding to the dual function payment card that was presented by said cardholder as identity proof for participating in the election event. It would be understood that the information received at step 302C may in an embodiment comprise information received from electoral authority 208 (for example in accordance with the method discussed previously in connection with FIG. 3B).

At step 304C, issuer server 206a determines an election event participation state change associated with the dual function payment card. Said election event participation state change is determined based on (i) a prior election event participation state of the dual function payment card, (ii) the received confirmation that the cardholder has participated in an election event and (iii) one or more predefined participation state change rules.

The participation state change rules may comprise one or more rules that define how an election event participation state change is to be determined based on at least (i) a prior election event participation state of the dual function payment card (which may have been previously recorded by issuer server 206a or which may be recorded on the dual function payment card and which may form part of the information communicated by electoral authority 208 to issuer 206), and (ii) the received confirmation that the cardholder has participated in an election event.

In an explanatory example, the prior election event participation state of the dual function payment card may comprise a numeric counter indicating the number of times the cardholder has participated in elections (or in a specific election) previously, and the predefined rules may determine that responsive to receiving confirmation that the cardholder has once again participated in the election, the resulting election event participation state change comprises incrementing the numeric counter. In another example, the prior election event participation state of the dual function payment card may simply indicate whether a cardholder has voted in a particular election yet—and the predefined rules may determine that responsive to receiving confirmation that the cardholder has voted in said election, the resulting election event participation state change comprises changing the status from “not voted” to “voted”. It would equally be understood that prior election event participation state records and the predefined rules could be more complex, and could enable tracking of multiple different elections in which a cardholder has or has not participated, and simultaneously enable allocation different weightages to different election events, with different election event participation state changes being implemented depending on any one or more of the previous election events the cardholder has participated in, the weightage allocated to such previous election events, the weightage allocated to the present election event in which the cardholder has participated, and one or more predefined rules for how these factors affect the election event participation state change etc.

At step 306C, issuer server 206a updates an election event participation state of the dual function payment card based on the determined election event participation state change. Said updated election event participation state may be recorded in issuer server database 206b in a data record corresponding to the cardholder's dual function payment card.

Step 308C thereafter comprises transmitting the updated election event participation state of the dual function payment card to a wallet application server 204a corresponding to a wallet application platform 204 at which the cardholder and the corresponding dual function payment card are enrolled for provision of digital wallet services—which election event participation state change may be recorded by said wallet application server 204a.

In an embodiment of the invention, responsive to recording of an updated election event participation state (at step 306C) corresponding to a dual function payment card, issuer server 206a additionally initiates an instruction for issue and dispatch of an new physical dual function payment card to the cardholder to replace the cardholder's existing dual function payment card—wherein the configuration of said new dual function payment card is selected from a plurality of available configurations and said selection is based on (i) the received updated election event participation state of the dual function payment card and (ii) a predefined set of physical configuration selection rules.

The physical configuration selection rules may comprise one or more rules that define how a configuration for a physical dual function payment card is to be determined based on a received updated election event participation state of the dual function payment card (as received at step 302D).

In an embodiment, the physical configuration selection rules may comprise a set of correlations between a determined election event participation state associated with a dual function payment card and a corresponding physical configuration for said dual function payment card that is used to issue a physical copy of the dual function payment card for forwarding to the cardholder. For example, the set of physical configuration selection rules may be defined such that (i) if the current election event participation state associated with a dual function payment card is “not voted”, a first physical configuration is selected—which first physical configuration causes the dual function payment card to be issued with a blue color scheme, blue design or blue substrate, while (ii) if the election event participation state associated with the dual function is “voted” in the context of a specific election, a second physical configuration is selected—which second physical configuration causes the dual function payment card to be issued with a green color scheme, green design or green substrate.

FIG. 3G is a simplified sequence flow diagram 300G representing an exemplary embodiment of a method for updating information regarding participation of a cardholder in an election event at a wallet application platform 204—at which platform 204 the cardholder has enrolled the dual function payment card for digital wallet services using said dual function payment card. The sequence flow diagram 300G includes the method steps 302C to 308C of FIG. 3C—but which steps have not been described again for the sake of brevity. The steps illustrated in FIG. 3G comprise steps 3002g and 3004g implemented between electoral authority server 308, issuer server 306 and wallet application server 304.

At step 3002g (and in response to electoral authority server 308 receiving confirmation of a cardholder's participation in an election event) electoral authority server 308 transmits to issuer server 306 (i) confirmation of the cardholder's participation in the election event and (ii) information corresponding to the cardholder's dual function payment card that was used as identity proof for participating in the election event.

Issuer server 306 uses the information received at step 3002g to update an election event participation state associated with the dual function payment card (which updation occurs in accordance with steps 304C and 306C of FIG. 3C). Thereafter at step 3004g, issuer server 306 transmits to wallet application server 304, an updated election participation state associated with said dual function payment card.

FIG. 3D illustrates a method for updating a display state of the dual function payment card at a user interface of a digital wallet with which a cardholder and a dual function payment card associated with said card holder have been enrolled for provision of digital wallet services—and wherein the display state of the dual function payment card is updated corresponding to an update in an election event participation state of said dual function payment card (in accordance with the method of FIG. 3C).

Step 302D comprises receiving at wallet application server 204a, an updated election event participation state of a dual function payment card enrolled with a wallet account created by the cardholder with the wallet application server 204a. It would be understood that said updated election event participation state of the dual function payment card may be received by wallet application server 204a as a result of the transmission of data described in connection with step 308C of FIG. 3C.

Step 304D comprises identifying a visual representation template corresponding to the dual function payment card, wherein the visual representation template is selected from a plurality of available visual representation templates, and said selection is based on (i) a received updated election event participation state of the dual function payment card and (ii) a predefined set of display state rules.

The display state rules may comprise one or more rules that define how a display state change is to be determined based on a received updated election event participation state of the dual function payment card (as received at step 302D).

In an embodiment, the display state rules may comprise a set of correlations between a determined election event participation state (or updated election event participation state) associated with a dual function payment card and a corresponding visual representation template that is used to render the dual function payment card on a user interface or on a display controlled by the digital wallet. For example, the set of display state rules may be defined such that (i) if the current election event participation state associated with a dual function payment card is “not voted”, a first visual representation template is selected—which first visual representation template may cause the dual function payment card to be rendered on a user interface or display screen in blue color or with a blue colored design, while (ii) if the election event participation state associated with the dual function is “voted” in the context of a specific election, a second visual representation template is selected—which second visual representation template may cause the dual function payment card to be rendered on a user interface or display screen in green color or with a green colored design.

In an embodiment, the display rules may be configured to correspond to the physical configuration selection rules described above in connection with FIG. 3D—such that the visual representation selected for a dual function payment card based on a determined election event participation state (or updated election event participation state) corresponds to, is similar to or is identical to a physical configuration selected for issuing a new dual function payment card to a cardholder in response to determination of an election event participation state (or updated election event participation state).

Step 306D comprises applying the selected visual representation template for display of the dual function payment card—and rendering a visual representation of the dual function display card within a display screen or display interface controlled by a wallet application software. The visual characteristics of the rendered visual representation of the dual function payment card on the display screen/display interface are determined by the selected visual representation template.

FIG. 3H is a simplified sequence flow diagram 300H representing an exemplary embodiment of a method for updating a display state of the dual function payment card at a user interface of a digital wallet with which a cardholder and a dual function payment card associated with said card holder have been enrolled for provision of digital wallet services (in accordance with the method of FIG. 3D). The sequence flow diagram 300H includes the method steps 302D to 306D of FIG. 3D—but which steps have not been described again for the sake of brevity. The steps illustrated in FIG. 3H comprise steps 3002h and 3004h implemented at wallet application server 304 and a display 310.

At step 3002h (and in response to issuer server 306 updating an election event participation state associated with a dual function payment card (as discussed in connection with FIGS. 3C and 3G above), wallet application server 304 receives (from issuer server 306) an updated election participation state associated with a dual function payment card. Responsive thereto, at step 3004h, wallet application server 304 transmits to a display 310, that is being used to display a visual representation of said dual function payment card, instructions for rendering a visual representation of the dual function payment card—wherein said rendered visual representation is based on the received updated election participation state.

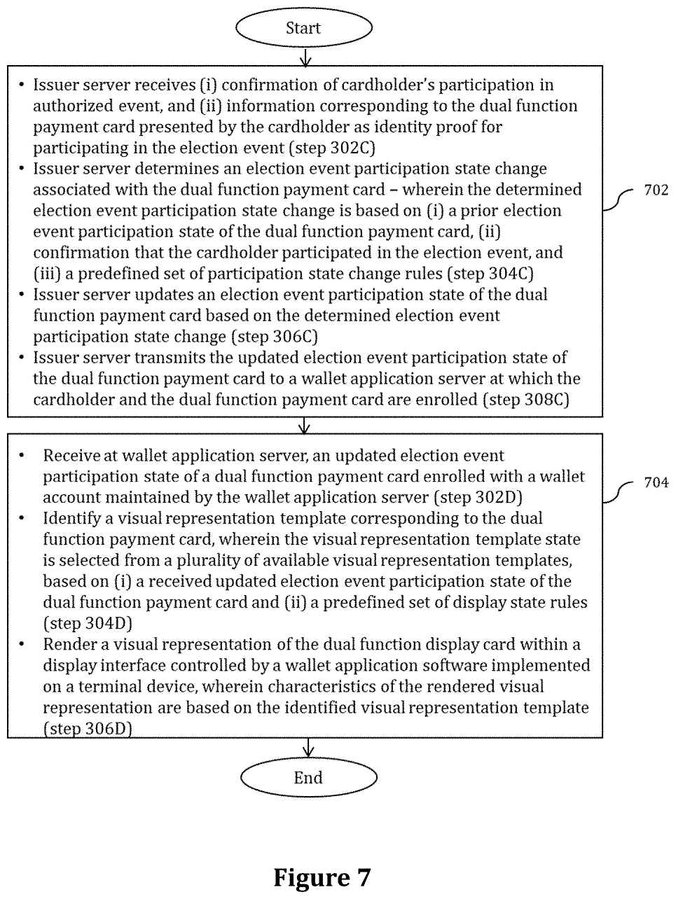

FIG. 7 summarily illustrates a method according to the teachings of the present invention, comprising a combination of steps of FIGS. 3C and 3D. Step 702 comprises implementation of steps 302C to 308C of FIG. 3C for the purposes of updating information regarding participation of a cardholder in an election event at a wallet application platform 204—at which platform 204, said dual function payment card has been enrolled for use with a digital wallet. Specifically, step 702 may include the steps of:
Issuer server receiving (i) confirmation of cardholder's participation in authorized event, and (ii) information corresponding to the dual function payment card presented by the cardholder as identity proof for participating in the election event,
Issuer server determining an election event participation state change associated with the dual function payment card—wherein the determined election event participation state change is based on (i) a prior election event participation state of the dual function payment card, (ii) confirmation that the cardholder participated in the election event, and (iii) a predefined set of participation state change rules,
Issuer server updating an election event participation state of the dual function payment card based on the determined election event participation state change, and
Issuer server transmitting the updated election event participation state of the dual function payment card to a wallet application server at which the cardholder and the dual function payment card are enrolled.

Thereafter, step 704 comprises implementation of steps 302D to 306D of FIG. 3D for the purposes of updating a display state of the dual function payment card at a user interface of a digital wallet with which a cardholder and a dual function payment card associated with said card holder have been enrolled for provision of digital wallet services. Specifically, step 704 may include the steps of:
Receiving at wallet application server, an updated election event participation state of a dual function payment card enrolled with a wallet account maintained by the wallet application server,
Identifying a visual representation template corresponding to the dual function payment card, wherein the visual representation template state is selected from a plurality of available visual representation templates, based on (i) a received updated election event participation state of the dual function payment card and (ii) a predefined set of display state rules, and
Rendering a visual representation of the dual function display card within a display interface controlled by a wallet application software implemented on a terminal device, wherein characteristics of the rendered visual representation are based on the identified visual representation template.

It would be understood that by combining the methods of FIGS. 3C and 3D (in the manner illustrated in FIG. 7, the display characteristics of a display rendering/visual rendering of a dual function payment card (through a digital wallet platform 204 with which the dual function payment card is enrolled), may be controlled to correspond to a cardholder's participation status in connection with one or more election events. The cardholder may use such visual indicators of participation in election events to show friends or colleagues—which contributes to the cardholder's social capital, and provides an incentive for participating in an election event. Such visual indicators may also result in other benefits that third party service providers may choose to provide such as entitling the cardholder entry into exclusive events, entitling the cardholder to avail of discounts by displaying such visual indicators etc.

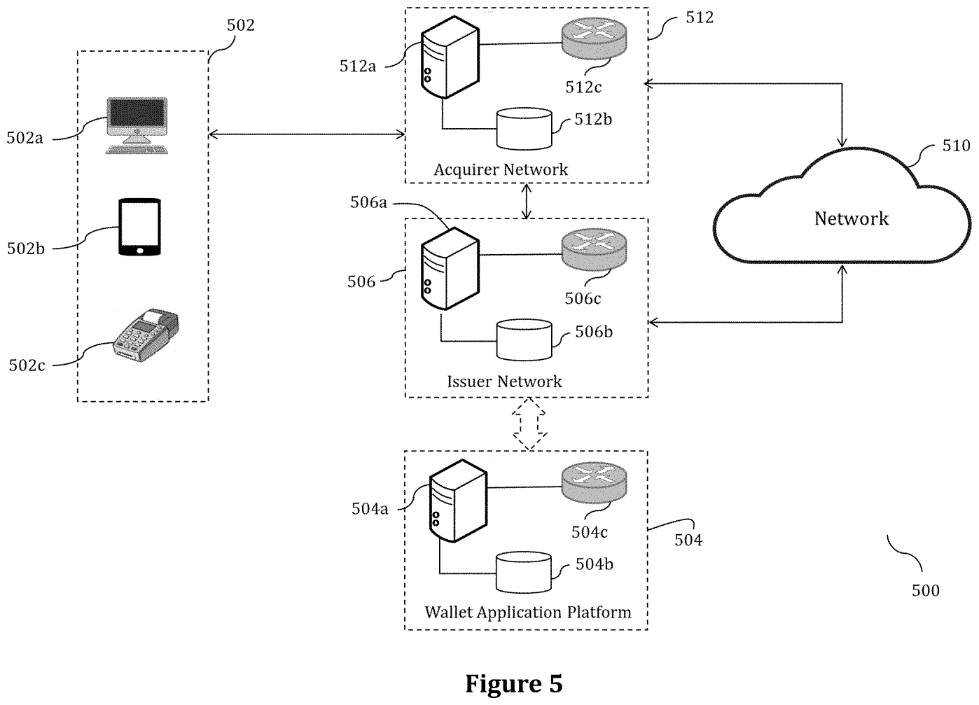

In certain embodiments of the invention that are hereinafter discussed in connection with FIGS. 5, 6 and 8, cardholders who participate in election events may also receive certain financial benefits/incentives as a result of such participation.

FIG. 5 illustrates a system environment 500 that can be used for implementing the “Get Out The Vote” solutions of the present invention—with the objective of providing financial benefits/incentives for participation in an election event. The system environment 500 is configured for provision of financial incentives such a discounts/rebates/cashback offers/other financial incentives or transaction offers to holders of dual function payment cards who have used such dual function payment cards as identity proof to participate in an election event.

System 500 includes a terminal device 502 from which a cardholder seeks to carry out a financial transaction such as a purchase transaction using said cardholder's dual function payment card. Said terminal device 502 may comprise any electronic data processing device having network communication capabilities that can be used to for the purpose of effecting a purchase transaction or other commercial transaction using the dual function payment card, and may include without limitation a computer/client terminal 502a, smartphone 502b or POS terminal 502c. Terminal device 502 may be configured for network communication with acquirer network 512.

The term “acquirer” refers to a business (e.g., a financial institution or a merchant bank) that contracts with a merchant to coordinate with the issuer network of a customers' payment card. Acquirer network 512 comprises a communication network, including hardware, software and other equipment used by an acquirer to transmit and process card based transactions and information related to merchants, customers, payment cards and transactions.

Acquirer network 512 is communicably coupled with terminal device 502, and comprises acquirer network server 512a, acquirer network database 512b and acquirer network interface gateway 512c. Acquirer network server 512a may be configured to receive and process information relating to dual function payment card transactions. In an embodiment, the acquirer network may receive or process transactions received only from merchants having a merchant account with the acquirer—which determination may be made based on information retrieved from acquirer network database 512b. Acquirer network interface gateway 512c may include a hardware or software network gateway configured to enable acquirer network 512 to communicate with network 510.

Issuer network 506 is a communication network corresponding to an issuer institution that has issued one or more payment cards, and includes hardware, software and other equipment used by an issuer to transmit and process payment card transactions and information related to customers, payment cards and transactions. Issuer network 506 comprises issuer network server 506a, issuer network database 506b and issuer network interface gateway 506c. Issuer network server 506a may be configured to receive and process information relating to payment card transactions. Issuer network database 506b stores data corresponding to payment cards issued by the issuer, and transactions related thereto. Issuer network interface gateway 506c may include a hardware or software network gateway configured to enable issuer network 506 for network communications.

System environment 500 additionally includes network 510 for facilitating communication between acquirer network 512 and issuer network 506. In an embodiment network 510 may comprise a card network i.e. an intermediary network between an acquirer bank and an issuer bank (for example, Mastercard® or Visa®). The card network primarily coordinates payment card transactions between acquirers and issuers, and additionally coordinates clearing and settlement services to transfer payments from issuers to merchants. In another embodiment, network 510 may comprise any communication network that enables data communication between two entities—for example, the internet or other internetwork.

Issuer network 506 may additionally be configured for network based communication with wallet application platform 504—which wallet application platform 504 comprises wallet application platform server 504a, wallet application platform database 504b and wallet application platform interface gateway 504c. Wallet application platform server 504a is configured to provide and enable access to network based digital wallet services through wallet application software implemented on a wallet access device such as client terminal 502 or through browser based access from said wallet access device/client terminal 502. Wallet application platform database 504b is configured to store data corresponding to wallet accounts maintained with said wallet application platform 504. Wallet application platform interface gateway 504c may include a hardware or software network gateway configured to enable wallet application platform 504 for network based data communication. It would be understood that wallet application platform 504 may be configured to implement one or more of the method steps described previously in connection with FIG. 3D.

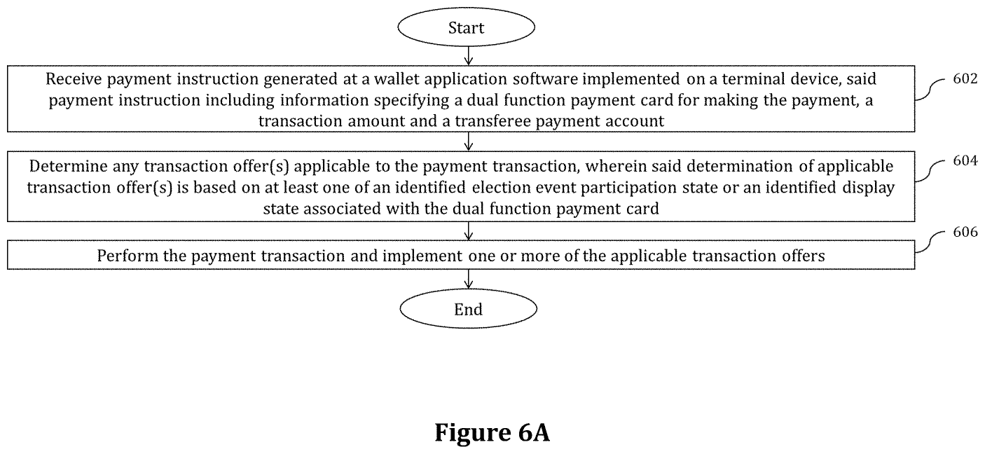

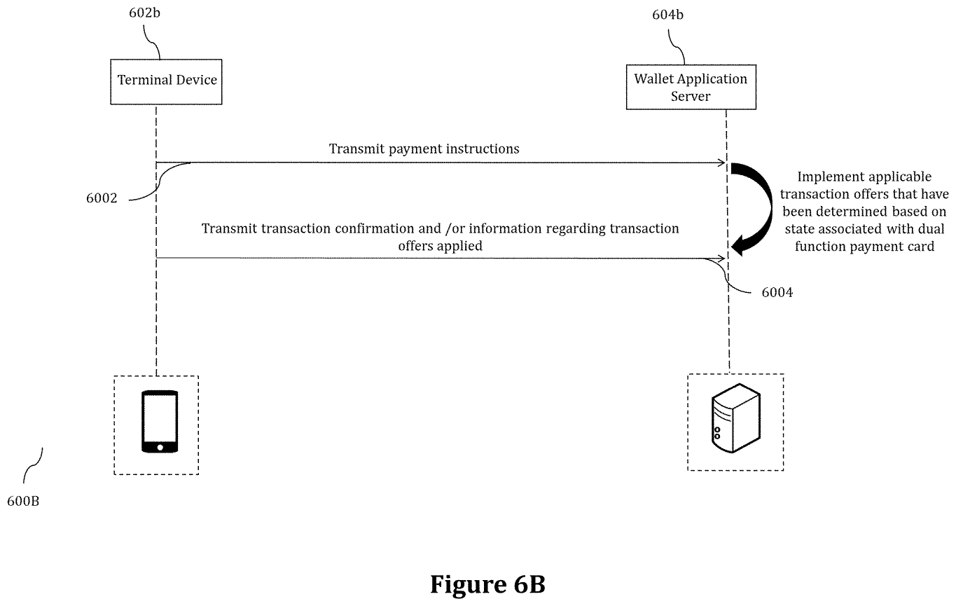

For the purposes of the invention, and particularly for the description of the method of FIG. 6A (which is described hereinbelow), it would be understood that issuer network 506 is an issuer network corresponding to an issuer bank associated with a dual function payment card—and is configured to implement one or more method steps of FIG. 3C.

FIG. 6A illustrates a method for provision of transaction related incentives or offers (for example discounts/rebates/cashback offers/other financial incentives) to holders of dual function payment cards who have used such dual function payment cards as identity proof to participate in an election event, and who are subsequently using said dual function payment card for performing a financial transaction or purchase transaction. The method of FIG. 6A is premised on a practice wherein one or more of merchants, acquirers, issuers or payment networks may provide transaction offers or transaction benefits such as discounts/rebates/cashback offers/other financial incentives to holders of dual function payment cards who have used such dual function payment cards as identity proof to participate in an election event.

For example, a payment network may provide an offer wherein persons who have voted in a legislative election can avail of cashbacks of 5% on all restaurants for a fixed period from the date of elections. The objective behind such transaction offers/transaction benefits would be to incentivize voting.

Step 602 of FIG. 6A comprises receiving a payment instruction or transaction instruction through a wallet application accessed through terminal device 502. The wallet application may comprise application software installed on terminal device 502 or may comprise server implemented application software that is accessed through a web browser on terminal device 502 (for example using web interface software of a cloud based digital wallet software service). The wallet application software enables a cardholder to access a digital wallet with which said cardholder maintains a digital wallet account, and at which digital wallet account said cardholder's dual function payment card has been enrolled.

The received payment instruction may in an embodiment be received at wallet application platform 504—and in a more particular embodiment may be transmitted to said wallet application platform 504 from terminal device 502. The payment instruction includes information specifying (i) a dual function payment card enrolled with the digital wallet, (ii) a transaction amount and (iii) a transferee payment account (for example, a merchant account to which the payment requires to be transferred).

Step 604 comprises determining any transaction offer(s) that are applicable to the payment transaction—wherein determination of applicable transaction offer(s) is based on at least one of (i) an identified election event participation state associated with the dual function payment card or (ii) an identified display state associated with the dual function payment card.

It would be understood that as a preliminary step, step 604 would involve identifying one or both of an election event participation state or a display state currently associated with the dual function payment card being used for the transaction. The election event participation state or display state of the dual function payment card shall be understood to comprise an election event participation state or display state of the type discussed previously in connection with FIGS. 3C and 3D. Said election event participation state or display state may be ascertained based on information retrieved from wallet application platform 504 (or optionally from issuer network 506.

Thereafter step 604 comprises checking with one or more of an issuer network 506, acquirer network 512, payment network 510 or wallet application platform 504 whether there are any transaction offer(s) applicable to said current election event participation state or current display state associated with the dual function payment card. Taking the previously discussed example, where a payment network 510 is providing an offer that persons who have voted in a legislative election can avail of a cashback of 5% on all restaurants for a fixed period from the date of elections, step 604 would involve (i) identifying either an election event participation state or display state associated with the dual function payment card being used for a payment transaction and (ii) determining whether the identified election event participation state or display state is indicative of cardholder participation in an election event to which the transaction offer applies.

Responsive to identification of one or more transaction offer(s) that are applicable to the payment transaction, step 606 comprises performing the payment transaction and implementing one or more of the applicable transaction offers. The payment transaction may be implemented by transferring the appropriate transaction amount from a payment account associated with the dual function payment card held with the issuer network 506, to a payment account held by the merchant with the acquirer network 512. Depending on the nature of the transactional offer, the transaction benefit may be provided by the transaction offer provider to the transaction offer beneficiary in an appropriate manner.

For example, where the transaction offer is a discount, the payment transaction amount transferred from the payment account associated with the dual function payment card to a merchant account may comprise a discounted transaction amount, and an amount equivalent to the discount (or a part of the discount) may subsequently be credited by the entity responsible for associating the transaction offer with participation an election event (for example, the issuer bank, acquirer bank, digital wallet platform or payment network) to the merchant account.

For example, where the transaction offer is a cashback offer, the payment transaction amount transferred from the payment account associated with the dual function payment card to a merchant account may comprise the transaction amount, and an amount equivalent to the cashback is subsequently credited by the entity responsible for associating the transaction offer with participation in an election event (for example, the issuer bank, acquirer bank, digital wallet platform or payment network) to the payment account associated with the dual function payment card.

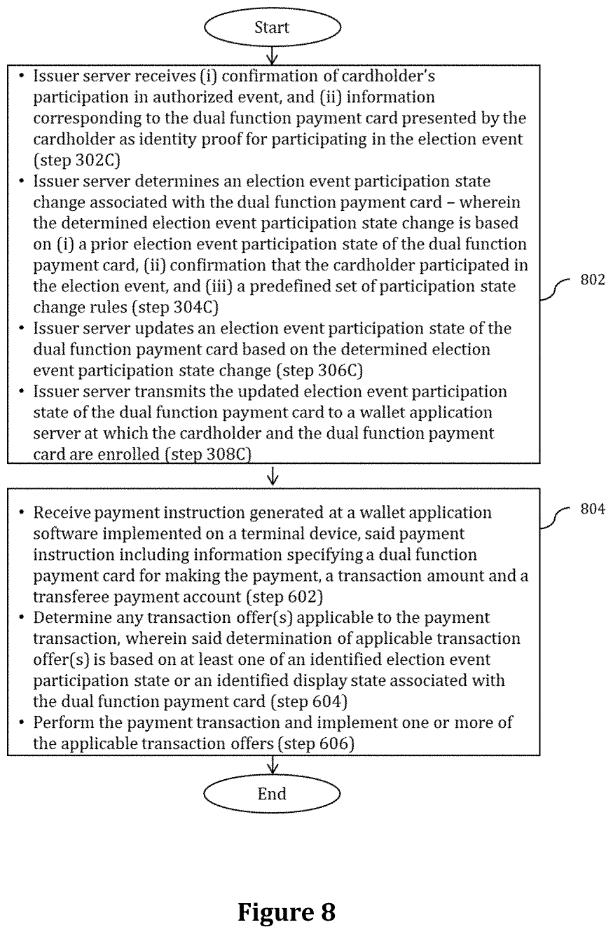

FIG. 8 summarily illustrates a method according to the teachings of the present invention, comprising a combination of steps of FIGS. 3C and 6. Step 802 comprises implementation of steps 302C to 308C of FIG. 3C for the purposes of updating information regarding participation of a cardholder in an election event at a wallet application platform 504—at which platform 504, said dual function payment card has been enrolled for use with a digital wallet. Specifically, step 802 may include the steps of:
Issuer server receiving (i) confirmation of cardholder's participation in authorized event, and (ii) information corresponding to the dual function payment card presented by the cardholder as identity proof for participating in the election event,
Issuer server determining an election event participation state change associated with the dual function payment card—wherein the determined election event participation state change is based on (i) a prior election event participation state of the dual function payment card, (ii) confirmation that the cardholder participated in the election event, and (iii) a predefined set of participation state change rules,
Issuer server updating an election event participation state of the dual function payment card based on the determined election event participation state change, and
Issuer server transmitting the updated election event participation state of the dual function payment card to a wallet application server at which the cardholder and the dual function payment card are enrolled

Thereafter, step 804 comprises implementation of steps 602 to 606 of FIG. 6A for provision of transaction related incentives or offers to holders of dual function payment cards who have used such dual function payment cards as identity proof to participate in an election event, and who are subsequently using said dual function payment card for performing a financial transaction or purchase transaction. Specifically step 804 may comprise the steps of:
Receiving payment instruction generated at a wallet application software implemented on a terminal device, said payment instruction including information specifying a dual function payment card for making the payment, a transaction amount and a transferee payment account,
Determining any transaction offer(s) applicable to the payment transaction of the payment, wherein said determination of applicable transaction offer(s) is based on at least one of an identified election event participation state or an identified display state associated with the dual function payment card, and
Performing the payment transaction and implementing one or more of the applicable transaction offers.

By implementing the methods in accordance with FIGS. 6 and 8, the invention enables provisions of financial incentives to individuals who participate in election events, with a view to increase voter participation, without seeking to alter or influence an outcome of the election event.

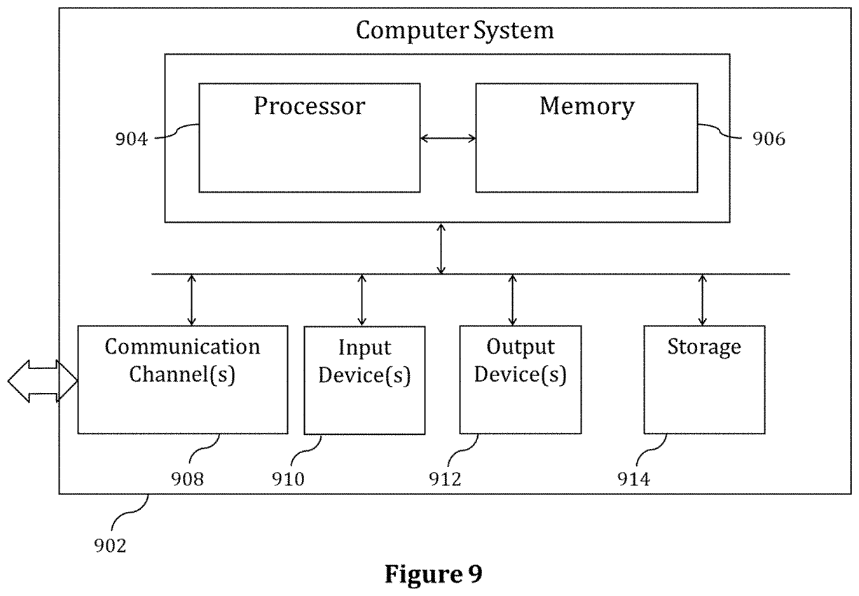

FIG. 9 illustrates an exemplary computer system 902 for implementing the present invention.

The illustrated system comprises computer system 902 which in turn comprises one or more processors 904 and at least one memory 906. Processor 904 is configured to execute program instructions—and may be a real processor or a virtual processor. It will be understood that computer system 902 does not suggest any limitation as to scope of use or functionality of described embodiments. The computer system 902 may include, but is not be limited to, one or more of a general-purpose computer, a programmed microprocessor, a micro-controller, an integrated circuit, and other devices or arrangements of devices that are capable of implementing the steps that constitute the method of the present invention. Exemplary embodiments of a computer system 902 in accordance with the present invention may include one or more servers, desktops, laptops, tablets, smart phones, mobile phones, mobile communication devices, tablets, phablets and personal digital assistants. In an embodiment of the present invention, the memory 906 may store software for implementing various embodiments of the present invention. The computer system 902 may have additional components. For example, the computer system 902 may include one or more communication channels 908, one or more input devices 910, one or more output devices 912, and storage 914. An interconnection mechanism (not shown) such as a bus, controller, or network, interconnects the components of the computer system 902. In various embodiments of the present invention, operating system software (not shown) provides an operating environment for various softwares executing in the computer system 902 using a processor 904, and manages different functionalities of the components of the computer system 902.

The communication channel(s) 908 allow communication over a communication medium to various other computing entities. The communication medium provides information such as program instructions, or other data in a communication media. The communication media includes, but is not limited to, wired or wireless methodologies implemented with an electrical, optical, RF, infrared, acoustic, microwave, Bluetooth or other transmission media.

The input device(s) 910 may include, but is not limited to, a touch screen, a keyboard, mouse, pen, joystick, trackball, a voice device, a scanning device, or any another device that is capable of providing input to the computer system 902. In an embodiment of the present invention, the input device(s) 910 may be a sound card or similar device that accepts audio input in analog or digital form. The output device(s) 912 may include, but not be limited to, a user interface on CRT, LCD, LED display, or any other display associated with any of servers, desktops, laptops, tablets, smart phones, mobile phones, mobile communication devices, tablets, phablets and personal digital assistants, printer, speaker, CD/DVD writer, or any other device that provides output from the computer system 902.

The storage 914 may include, but not be limited to, magnetic disks, magnetic tapes, CD-ROMs, CD-RWs, DVDs, any types of computer memory, magnetic stripes, smart cards, printed barcodes or any other transitory or non-transitory medium which can be used to store information and can be accessed by the computer system 902. In various embodiments of the present invention, the storage 914 may contain program instructions for implementing any of the described embodiments.

In an embodiment of the present invention, the computer system 902 is part of a distributed network or a part of a set of available cloud resources.

The present invention may be implemented in numerous ways including as a system, a method, or a computer program product such as a computer readable storage medium or a computer network wherein programming instructions are communicated from a remote location.

The present invention may suitably be embodied as a computer program product for use with the computer system 902. The method described herein is typically implemented as a computer program product, comprising a set of program instructions that is executed by the computer system 902 or any other similar device. The set of program instructions may be a series of computer readable codes stored on a tangible medium, such as a computer readable storage medium (storage 914), for example, diskette, CD-ROM, ROM, flash drives or hard disk, or transmittable to the computer system 902, via a modem or other interface device, over either a tangible medium, including but not limited to optical or analogue communications channel(s) 908. The implementation of the invention as a computer program product may be in an intangible form using wireless techniques, including but not limited to microwave, infrared, Bluetooth or other transmission techniques. These instructions can be preloaded into a system or recorded on a storage medium such as a CD-ROM, or made available for downloading over a network such as the Internet or a mobile telephone network. The series of computer readable instructions may embody all or part of the functionality previously described herein.

Based on the above, it would be apparent that the present invention enables creation of both social incentives and financial incentives for holders of dual function payment cards to participate in election events—thereby increasing voter participation for the election event.

While the exemplary embodiments of the present invention are described and illustrated herein, it will be appreciated that they are merely illustrative. It will be understood by those skilled in the art that various modifications in form and detail may be made therein without departing from or offending the spirit and scope of the invention as defined by the appended claims. Additionally, the invention illustratively disclose herein suitably may be practiced in the absence of any element which is not specifically disclosed herein—and in a particular embodiment that is specifically contemplated, the invention is intended to be practiced in the absence of any one or more element which are not specifically disclosed herein.

What is claimed is:

1. A method for increasing voter participation in an election event, the method comprising:
receiving confirmation of a cardholder's participation in an election event, wherein said cardholder is associated with a dual function payment card;
determining an election event participation state change associated with the dual function payment card, wherein said election event participation state change is determined based on (i) a prior election event participation state of the dual function payment card, (ii) the received confirmation that the cardholder has participated in the election event, and (iii) one or more predefined participation state change rules;
updating a recorded election event participation state of the dual function payment card based on the determined election event participation state change; and
receiving the updated election event participation state at a processor wallet application server configured to implement functionality associated with a wallet account corresponding to the cardholder, wherein said dual function payment card has been enrolled with said wallet account.

2. The method as claimed in claim 1, wherein at least the step of receiving the updated election event participation state is performed at a processor implemented within a client terminal that enables access to the wallet account.

3. The method as claimed in claim 1, wherein at least the step of receiving the updated election event participation state is performed at a wallet application server configured to implement functionality associated with a wallet account corresponding to the cardholder, wherein said dual function payment card has been enrolled with said wallet account.

4. The method as claimed in claim 1, wherein the wallet application server identifies a visual representation template corresponding to the dual function payment card, and wherein identification of the visual representation template comprises selection of said visual representation template from a plurality of available visual representation templates, and said selection is based on (i) the received updated election event participation state of the dual function payment card and (ii) a predefined set of display state rules.

5. The method as claimed in claim 4, comprising rendering a visual representation of the dual function payment card on a display interface, wherein visual characteristics of the rendered visual representation of the dual function payment card are determined by the identified visual representation template.

6. The method as claimed in claim 5, wherein visual characteristics of the rendered visual representation of the dual function payment card that are determined by the identified visual representation template includes a specific color configuration used to display the dual function payment card on the display interface.

7. The method as claimed in claim 6, wherein a first color configuration determined by a first visual representation template within the plurality of visual representation templates is different from a second color configuration determined by a second visual representation template within the plurality of visual representation templates.

8. The method as claimed in claim 1, comprising the steps of:
receiving a payment instruction for a payment transaction based on the dual function payment card;
identifying a transaction offer applicable to the payment transaction, wherein identification of the transaction offer is based on an identified election event participation state associated with the dual function payment card; and
implementing the payment transaction and the identified transaction offer.

9. A system for increasing voter participation in an election event, the system comprising:
an issuer network server configured for performing the method of claim 1.

10. The system of claim 9, further comprising:
either of a wallet application server or a processor implemented within a client terminal that enables access to a wallet account, configured to:
maintain a wallet account corresponding to the cardholder, wherein said dual function payment card has been enrolled with said wallet account; and
receive the updated election event participation state from the issuer network server.

11. The system as claimed in claim 10, wherein the wallet application server is configured to identify a visual representation template corresponding to the dual function payment card, wherein said identification of the visual representation template comprises selection of said visual representation template from a plurality of available visual representation templates, and wherein said selection is based on (i) the received updated election event participation state of the dual function payment card and (ii) a predefined set of display state rules.

12. The system as claimed in claim 11, wherein the wallet application server or wallet application software in communication with said wallet application server is configured to render a visual representation of the dual function payment card on a display interface, wherein visual characteristics of the rendered visual representation of the dual function payment card are determined by the identified visual representation template.

13. The system as claimed in claim 12, wherein visual characteristics of the rendered visual representation of the dual function payment card that are determined by the identified visual representation template includes a specific color configuration used to display the dual function payment card on the display interface.

14. The system as claimed in claim 13, wherein a first color configuration determined by a first visual representation template within the plurality of visual representation templates is different from a second color configuration determined by a second visual representation template within the plurality of visual representation templates.

15. The system as claimed in claim 9, configured to:
receive a payment instruction for a payment transaction based on the dual function payment card;
identify a transaction offer applicable to the payment transaction, wherein identification of the transaction offer is based on an identified election event participation state associated with the dual function payment card; and
implement the payment transaction and the identified transaction offer.

16. A method for increasing voter participation in an election event, the method comprising:
receiving, at a wallet application server, an election event participation state corresponding to a dual function payment card, wherein said wallet application server is configured to maintain a wallet account corresponding to a cardholder of said dual function payment card, and wherein said dual function payment card has been enrolled with said wallet account;
identifying a visual representation template corresponding to the dual function payment card, wherein identification of the visual representation template comprises selection of said visual representation template from a plurality of available visual representation templates, and said selection is based on (i) the received election event participation state of the dual function payment card and (ii) a predefined set of display state rules; and
rendering a visual representation of the dual function payment card on a display interface, wherein visual characteristics of the rendered visual representation of the dual function payment card are determined by the identified visual representation template;
wherein the election event participation state corresponding to the dual function payment card has been determined based on:
a received confirmation of a cardholder's participation in an election event; and
determination of an election event participation state change associated with the dual function payment card, wherein said election event participation state change is determined based on (i) a prior election event participation state of the dual function payment card, (ii) the received confirmation that the cardholder has participated in the election event, and (iii) one or more predefined participation state change rules.

17. A wallet application platform configured for increasing voter participation in an election event, said wallet application platform comprising the wallet application server of claim 16.

18. A method for increasing voter participation in an election event, the method comprising:
receiving a payment instruction for a payment transaction based on a dual function payment card;
identifying a transaction offer applicable to the payment transaction, wherein identification of the transaction offer is based on an identified election event participation state associated with the dual function payment card; and
implementing the payment transaction and the identified transaction offer;
wherein identification of the election event participation state corresponding to the dual function payment card is based on:
a received confirmation of a cardholder's participation in an election event; and
determination of an election event participation state change associated with the dual function payment card, wherein said election event participation state change is determined based on (i) a prior election event participation state of the dual function payment card, (ii) the received confirmation that the cardholder has participated in the election event, and (iii) one or more predefined participation state change rules.

19. A system configured for increasing voter participation in an election event, the system comprising a server configured to perform the method of claim 18.
